(19) United States
(12) Patent Application Publication
(10) Pub. No.: US 2008/0280784 A1
(43) Pub. Date: Nov. 13, 2008

(54) APPARATUS AND METHOD FOR USE IN SOLID PHASE CHEMICAL SYNTHESIS

(75) Inventors: Joseph W. Guiles, Bedminster, NJ (US); Gregory Shutske, Pittstown, NJ (US)

Correspondence Address: ANDREA Q. RYAN;SANOFI-AVENTIS U.S. LLC, 1041 ROUTE 202-206, MAIL CODE: D303A, BRIDGEWATER, NJ, 08807, US

(73) Assignee: Aventis Pharmaceuticals Inc., Bridgewater, NJ (US)

(21) Appl. No.: 12/175,810

(22) Filed: Jul. 18, 2008

Related U.S. Application Data
(63) Continuation of application No. 10/611,092, filed on Jul. 1, 2003.
(60) Provisional application No. 60/393,999, filed on Jul. 5, 2002.

(30) Foreign Application Priority Data
Nov. 2, 2002 (GB) 0225631.1

(51) Int. Cl. C40B 50/14; C40B 60/14

(52) U.S. Cl. 506/30; 506/40

(57) ABSTRACT

An apparatus is disclosed for use in solid-phase chemical synthesis procedures. The apparatus allows the separation of a cleaved product from the solid-phase used to make the product, and subsequent removal of the solid-phase from the apparatus. The apparatus allows the cleaved product to be concentrated within the apparatus without transfer to another device.

### FIELD OF THE INVENTION

The present invention relates to the field of devices and methods for chemical synthesis. More particularly, the present invention relates to an efficient apparatus and a method for separation of solid and liquid phases in high-throughput, solid phase organic synthesis, such as used in the practice of combinatorial chemistry. The invention provides an apparatus and a method for handling a plurality of solid phase reactors and the collection of products produced by those solid phase reactors. The present invention is particularly applicable for combinatorial synthesis of organic molecules, whether as part of an automated or a manual procedure.

### BACKGROUND OF THE INVENTION

Solid phase synthesis of organic molecules is the method of choice for preparation of libraries and arrays of compounds, which are being used for screening in the quest to find new drug candidates or pharmaceutical lead compounds, i.e., compounds which exhibit a particular biological activity of pharmaceutical interest, and which can serve as a starting point for the selection and synthesis of a drug compound, which in addition to the particular biological activity of interest has pharmacologic and toxicologic properties suitable for administration to animals, and especially humans. Manual synthesis requires repetitions of several relatively simple operations such as addition of reagents, incubation and separation of solid and liquid phases, and removal of liquids. This character of the synthetic process renders it optimal for automation. Several designs of automated instruments for combinatorial synthesis have appeared in the patent and non-patent literature. Constructions based on specialized reactors connected permanently (or semi-permanently) to containers for the storage of reagents are strongly limited in their throughput. The productivity of automated instruments can be dramatically improved by use of disposable reaction vessels (such as multiwell plates or test tube arrays) into which reagents are added by pipetting, or by direct delivery from storage containers.

Liquid removal from the reaction vessel or reactor is usually accomplished by filtration through a filter-type material. The drawback of this method is the potential clogging of the filter, leading to extremely slow liquid removal, or to contamination of adjacent reactor compartments. An alternative technique based on the removal of liquid by suction from the surface above the sedimented solid phase is limited due to incomplete removal of the liquid from the reaction volume. See U.S. Pat. No. 6,045,755 issued on Apr. 4, 2000.

The present application is an improvement upon U.S. Pat. Nos. 5,202,418, 5,338,831 and 5,342,585 which describe placement of resin in polypropylene mesh packets and removal of liquid through the openings of these packets (therefore this process is basically filtration), or removal of the liquid from the pieces of porous textile-like material by centrifugation.

Liquid removal by centrifugation was described and is the subject of several publications (see the book “Aspects of the Merrified Peptide Synthesis” by Christian Birr in the series Reactivity and Structure Concepts in Organic Chemistry vol. 8, K. Hafner, J.-M. Lehn, C. W. Rees, P. von Rague Schleyer, B. M. Trost, R. Zahradnik, Eds., Springer-Verlag, Berlin, Heidelberg, New York, 1978, and German Patent Application P 20 17351.7, G. 70 13256.8, 1970. These references describe the use of centrifugation for liquid removal from slurry of solid phase particles in a concentrical vessel equipped with a filtration material in its perimeter and spun around its axis.

There still remains however a need for a simple, efficient means of separating liquid and solid phases during solid phase synthesis of organic molecules, particularly a method amenable to use with automated methods for such syntheses and allowing easy recovery of a product cleaved from an active solid surface used in a solid phase reactor.

Tube holding racks for use in immunoassays are a very different type of application than the art of chemical synthesis. The present invention is concerned with an apparatus and method for producing new chemical compounds, that can then be tested for biological activity. In marked contrast, immunoassays are an art concerned with making quantitative determinations of the amount of a substance.

A description of the techniques used for carrying out solid phase chemical synthesis reactions is provided in “Combinatorial Chemistry” by Nicholas K. Terrett, ISBN 0-19-850219-2 (1998), Oxford University Press, which is hereby incorporated by reference.

In industries such as the pharmaceutical industry, compounds are frequently synthesized for testing purposes. One technique for accomplishing the synthesis involves subjecting a resin-bound starting molecule to a series of reagent chemicals that react with the starting molecule in such a manner to achieve the desired synthesized compound. A description of this technique is provided in “Solid Phase Synthesis”, by J. M. Stewart and J. D. Young, second edition (ISBN #0-935940-03-0, copyright 1984), published by Pierce Chemical Company of Rockford, Ill., which is incorporated herein by reference.

Manually handling reaction vessels during this process is cumbersome and labor intensive, especially when large lots of compounds are being created simultaneously. To address this problem, various articles of sophisticated laboratory equipment have been developed. For example, commercial solid phase synthesizers (e.g., The Advanced ChemTech Model 396 synthesizer) can perform simultaneous reactions in up to ninety-six separate polypropylene wells. However, the relatively high cost of such equipment typically precludes smaller, individual laboratories from obtaining these synthesizers as standard equipment. Even larger laboratories faced with projects of modest proportion may find such equipment to be cumbersome and/or unnecessary for many routine uses.

Another synthesizer known as the Multiblock, which is available from Peptides International, Inc. of Louisville, Ky., allows chemists or users to synthesize forty-two samples simultaneously. While more affordable than many prior art synthesizers, the Multiblock may still be too expensive for some laboratories. Other shortcomings of the Multiblock result from the fact that assemblies known as multistoppers are typically used to seal all of the reaction vessels during the reaction process. Besides being constructed of component parts which may require repair or maintenance over time, these multistoppers require all of the reaction vessels to be unsealed when an operator wishes to unseal the multistopper and remove only a single reaction vessel held within the Multiblock synthesizer. Still further, the Multiblock's use of a bulky set of plates attachable with spanning shafts results in a somewhat cumbersome and inflexible design.

One advantage of the present invention is that numerous reaction vessels may be simultaneously handled in a convenient and user friendly fashion during multiple simultaneous chemical synthesis. The present invention provides a convenient apparatus and method that allows easy recovery of product cleaved from a solid phase chemical synthesis reactor.

### SUMMARY OF THE INVENTION

The present invention provides a new apparatus for use in chemical synthesis, comprising:
at least one reactor, the at least one reactor comprising an active solid surface for solid-phase synthesis of a product;
at least one receiving container, the at least one receiving container having a bore dimensioned to receive the at least one reactor at a first bore end, and having a cavity for receiving a reaction product, the cavity disposed at a second bore end and depending from the receiving container bore, the cavity having a diameter less than a diameter of the bore; and
a receiving container holder, the receiving container holder having a plurality of holding position bores disposed in a horizontal array, each of the plurality of holding position bores extending vertically through the receiving container holder;
   wherein the at least one receiving container is removably engageable to at least one of the plurality of holding position bores, for retaining the at least one receiving container to the receiving container holder when the receiving container holder is inverted.

In one exemplary embodiment of an apparatus according to the teachings of the present invention, a receiving container holder is provided that has a plurality of holding position bores disposed in a horizontal array. Each of these holding position bores extend vertically through the receiving container holder. The receiving container holder is capable of holding a receiving container in each of the holding position bores. The receiving container has a bore that is dimensioned to receive a reactor that has an active solid surface, of the type known in the art of solid phase chemical synthesis. Disposed at one end of the receiving container bore is a cavity. In use, after a chemical reaction on the active solid surface has produced a product, the product may be cleaved by a reaction, such reactions being known in the art, to release the product. The cavity is sized to not admit the reactor.

The product may be collected from the reactor and into the cavity by application of centrifugal force directed toward the second bore end. This may be accomplished either simultaneously with, or preceding the use of a vacuum to remove any solvent present from the product in the cavity.

The present invention also provides a method. This is a method for separating a substance from an active solid surface, comprising:
a) providing an apparatus as taught by the present description above;
b) cleaving the product from the active solid surface of the at least one reactor, while the at least one reactor is received within the at least one receiving container;
c) collecting the cleaved product in the cavity of the at least one receiving container by application of centrifugal force;
d) evaporating any solvent present in the at least one receiving container; and
e) removing the at least one reactor from the at least one receiving container by inversion of the at least one receiving container from a first, reactor retaining position to a second, reactor releasing position.

In a preferred embodiment of the new method, the steps c) and d) are carried out simultaneously.

It is to be understood that an individual receiving container may be removed from a receiving container holder while other individual receiving containers remain engaged to the receiving container holder. That is, a person skilled in the art will appreciate that an individual receiving container may be removed from a receiving container holder to allow manipulation of a product that has been collected within that receiving container. And, this may be done while leaving other receiving containers engaged to the receiving container holder. This allows either manual or robotic transport of product samples from one receiving container holder to another, for use in protocols of combinatorial chemical synthesis.

The reaction may be carried out on an active portion of the surface of a solid reactor article that can be received by the receiving container or alternatively, the reaction may be carried out on the entire surface of an article that can be received by the reactor holder. In yet another alternative, the reaction may be carried out on the surface of a plurality of articles that comprise the reactor. In this latter alternative, it is to be appreciated that particulate material with a suitable surface for carrying out a solid-phase synthesis is to be preferred in use of the present invention. Beads of a small size, and having a suitable surface for carrying out a solid-phase synthesis, are especially preferred for use with the present invention. Reactors in the form of rods or pins are also suitable for use with the present invention.

A suitable reactor is available commercially from Mimotopes Inc., 11772 Sorrento Valley Road, San Diego, Calif. 92121 as the “SynPhase Lantern.” Additional suitable reactors for solid-phase chemical synthesis are known to those skilled in the art. An alternative reactor type that can be used with the present invention is also available in the form of NanoKans® from Irori Inc. Reactors in the form of rods or pins are also suitable for use with the present invention.

### BRIEF DESCRIPTION OF THE DRAWINGS

FIG. 1 is a perspective view of an embodiment of an apparatus according to the teachings of the present invention.

FIG. 2 is a top plan view of this embodiment according to the teachings of the present invention.

FIG. 3 is a sectional elevation view of the embodiment of FIG. 2.

FIG. 4 is an exploded view of a receiving container holder, according to the teachings of the invention.

FIG. 5 is a sectional view of the embodiment of FIG. 3, showing the embodiment in alternate positions.

FIG. 6 is top plan view of this embodiment, showing four receiving container holders mounted in a centrifuge.

FIG. 7 is a top plan view of this embodiment, showing four receiving container holders mounted in a centrifuge, with the centrifuge in rotation.

### DETAILED DESCRIPTION OF THE INVENTION

The invention disclosed here provides both an apparatus for use in carrying out solid-phase chemical synthesis, and a method for carrying out such synthesis. In particular, the present invention provides an apparatus and method that are of particular valuable utility in recovering a cleaved product from a solid-phase chemical reaction. By cleaved product is meant here a product cleaved from a solid phase after a chemical reaction that has taken place upon the solid phase, the cleaved product being the product desired from the reaction. The new apparatus and method will be understood by those skilled in the art of chemical synthesis by reference to the accompanying drawing figures.

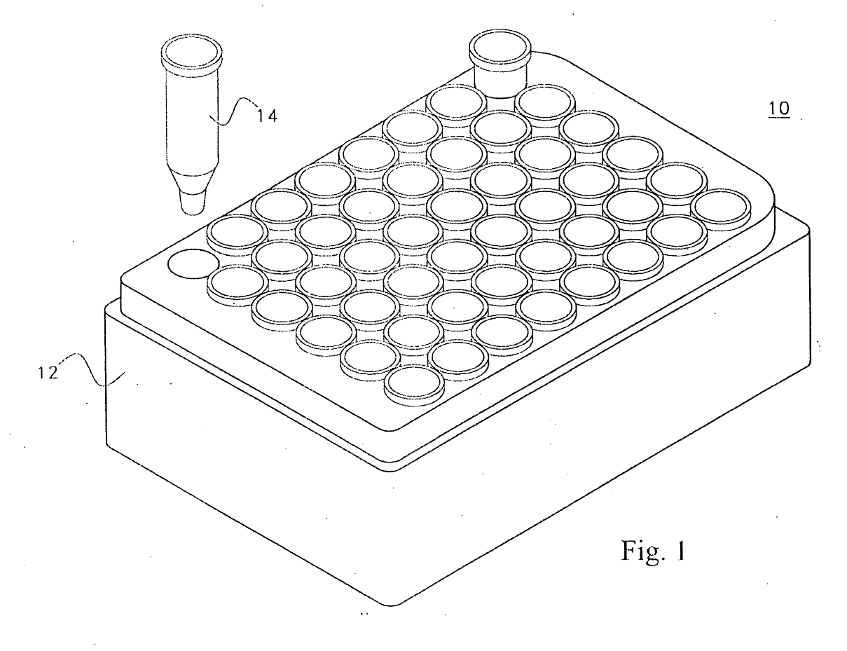

One embodiment 10 of the new apparatus may be seen in perspective in FIG. 1. In this embodiment the apparatus comprises a receiving container holder 12, that for this embodiment is in the form of a rectangular block. The apparatus also comprises at least one receiving container 14.

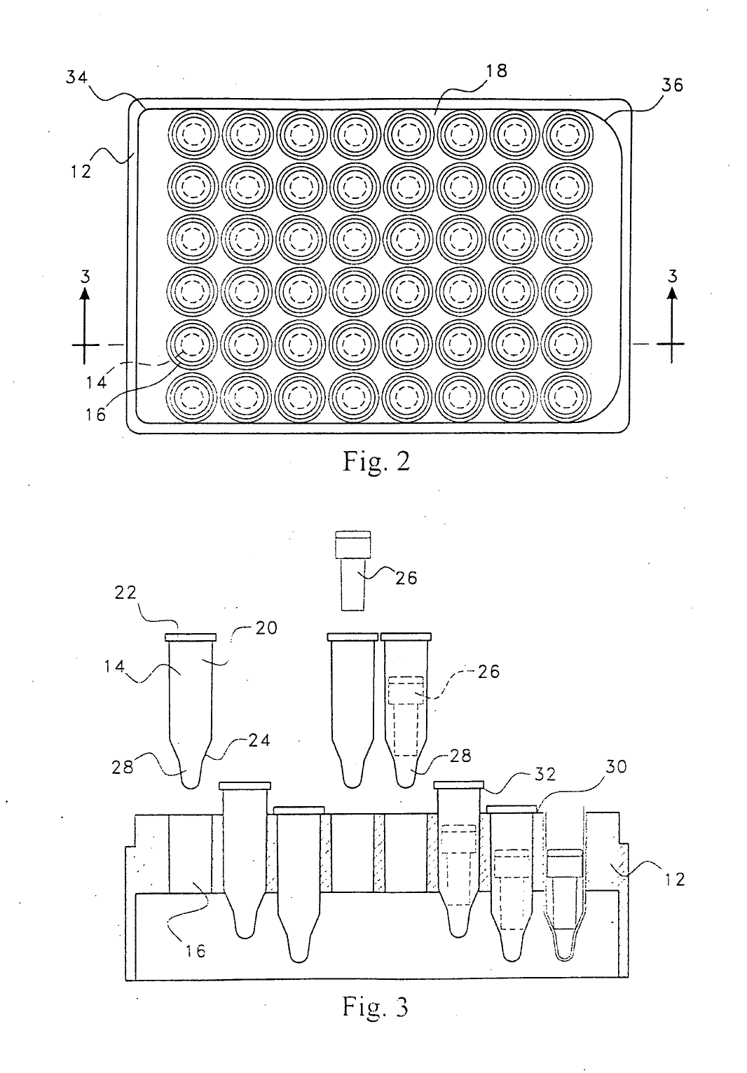

In FIG. 2 illustrates a top plan view of the receiving container holder 12. This receiving container holder 12 has a plurality of holding position bores 16 that are preferably disposed in a horizontal array 18. The horizontal array 18 may be of a shape chosen by one skilled in the art for convenience in a particular use, for example for use in a particular type of robotic handling machine. Preferably, the horizontal array 18 is rectangular. From the sectional view illustrated in FIG. 3, it may be seen that each holding position bore 16 extends vertically through the receiving container holder 12. Each of these holding position bores 16 is preferably dimensioned to closely receive a receiving container 14. The receiving container 14 has a bore 20, that has a first bore end 22 and a second bore end 24. The first bore end 22 is dimensioned to receive a reactor 26. The reactor 26 comprises an active solid surface for solid-phase synthesis of a product. The receiving container 14 also has a cavity 28, that is disposed at the second bore end 24 and which depends from the receiving container bore 20. Preferably, the cavity 28 is tapered such that its diameter decreases as it depends from the second bore end 24. That is, its cross section is tapered. This tapering may be useful for collecting a cleaved reaction product on a small area of the interior surface of the cavity. The cavity 28 has a diameter that is less than a diameter of the bore of the receiving container 14, for excluding the reactor 26 from the cavity.

The receiving container 14 is removably engageable to the holding position bore 16. The engagement is sufficiently strong to retain the receiving container 14 to the receiving container holder 12 when the receiving container holder 12 is inverted. The removable engagement may be by a friction fit of the receiving container 14 to the receiving position bore 16, that is by a friction fit of the receiving container 14 to the receiving container holder 12 at a receiving position bore 16. Alternatively, the removable engagement may be by elastic deformation of both the receiving container 14 and the receiving container holder 12. Also alternatively, the removable engagement may be by elastic deformation of either the receiving container 14 or the receiving container holder 12.

It is preferred that the receiving container 14 and the receiving container holder 12 each be constructed of a polymeric material, where the polymeric material selected for each may be the same polymeric material or a different polymeric material. Examples of suitable polymeric materials include polypropylene, polyethylene, or a copolymer. Suitability of a polymeric material may be readily determined by consideration of the need for insolubility in the solvents used in carrying out chemical reactions of solid-phase chemical synthesis, and the requirements for removable engagement described above.

The elastic deformation may be accomplished by a snap fit of the receiving container 14 to the receiving position bore 16, that is by a snap fit of the receiving container 14 to the receiving container holder 12 at a receiving position bore 16. Such a snap fit may be accomplished by providing a protruding structural element on either the receiving container 14 or the receiving position bore 16, the protruding structural element being dimensioned to be closely received within a mating structural element of the article being removably engaged. An example of a construction of this latter type is the provision of a protruding ring or annular ridge around a receiving container, and provision of a corresponding groove disposed on the receiving container holder which mates with the ring or ridge for removable engagement.

The removable engagement of the new apparatus provides for engagement of the receiving container 14 to the receiving container holder 12, in an engaged position 30, where the receiving container 14 is retained by the receiving container holder 12 when the receiving container holder 12 is inverted. When either the engagement by friction fit or alternatively by elastic deformation is released, the receiving container 14 is movable to a released position 32. In this latter released position 32, the receiving container 14 may be removed by gravity when the receiving container holder 12 is inverted. The receiving container 14 may be moved from the engaged position 30 to the released position 32 by application of mechanical force. This mechanical force may be applied manually by a hand of an operator, or it may be applied robotically by action of a finger or lever acting from below the receiving container 14.

The receiving container holder 12 of this embodiment is rectangular, having four spaced apart corners 34 in a horizontal plane, each of the four spaced apart corners having a shape; and wherein the shape of at least one of the four spaced apart corners is shaped differently from the shape of the other of the four spaced apart corners to form an indexing element 36, here a rounded corner. This arrangement is illustrated in FIG. 2. The indexing element 36 is an asymmetric element disposed about the receiving container holder, for providing identification of the orientation of the receiving container holder in a horizontal plane. The indexing element may be an indentation disposed about the periphery of the receiving container holder 12, a protrusion depending from the periphery of the receiving container holder, or a rounded portion of the periphery of receiving container holder as depicted here in this embodiment. The function of the indexing element is to provide that at least one portion of the periphery of the receiving container holder 12 be physically distinguishable from the rest of remainder of the periphery, such that the orientation of the apparatus around a vertical axis can be readily determined. This provides for easy recognition of the orientation of the receiving container holder 12 by a human user or a robotic manipulator, as will be recognized by those skilled in the art of combinatorial chemical synthesis.

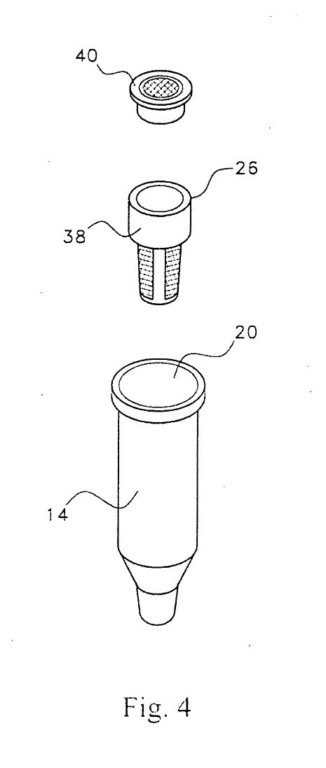

In FIG. 4 may be seen that the receiving container 14 of this embodiment has a receiving bore 20 for receiving a reactor 26. This reactor 26 is of the type available commercially as Mikrokans® as described above. The reactor 26 is comprised of a lower basket portion 38 and a cap portion 40. A solid phase having an active solid surface for solid-phase synthesis of a product is disposed within the basket portion 38 and retained by the cap portion 40.

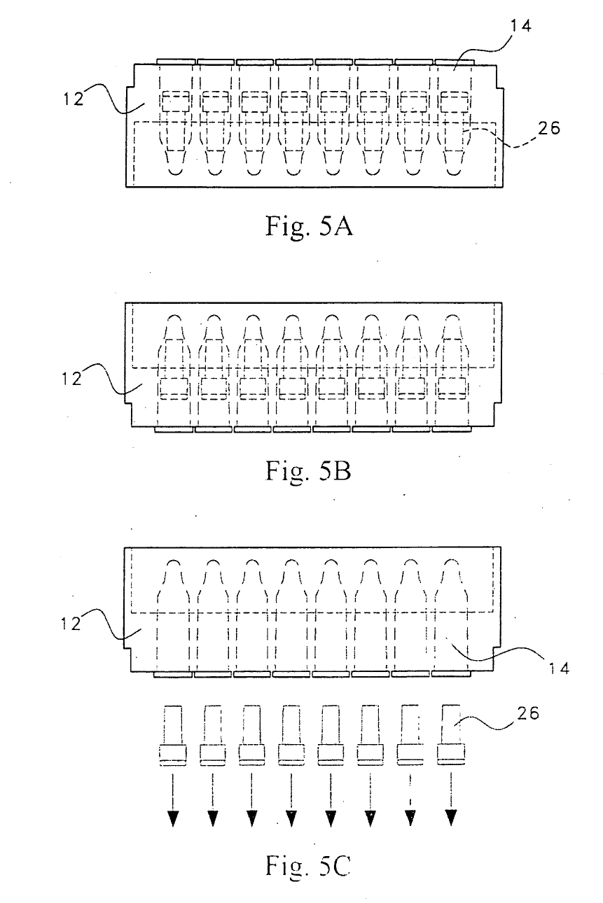

In FIG. 5 is illustrated part of a method of using the new apparatus. Illustrated in FIG. 5A is the inventive apparatus in a first, reactor retaining position. After a chemical reaction has been carried out within a receiving container 14 that is in the engaged position in the receiving container 12, the reaction having been carried out on an active solid surface associated with the reactor 26, the apparatus is inverted to a second, reactor releasing position illustrated in FIG. 5B. By force of gravity, the reactor 26 is removed from the receiving container 14.

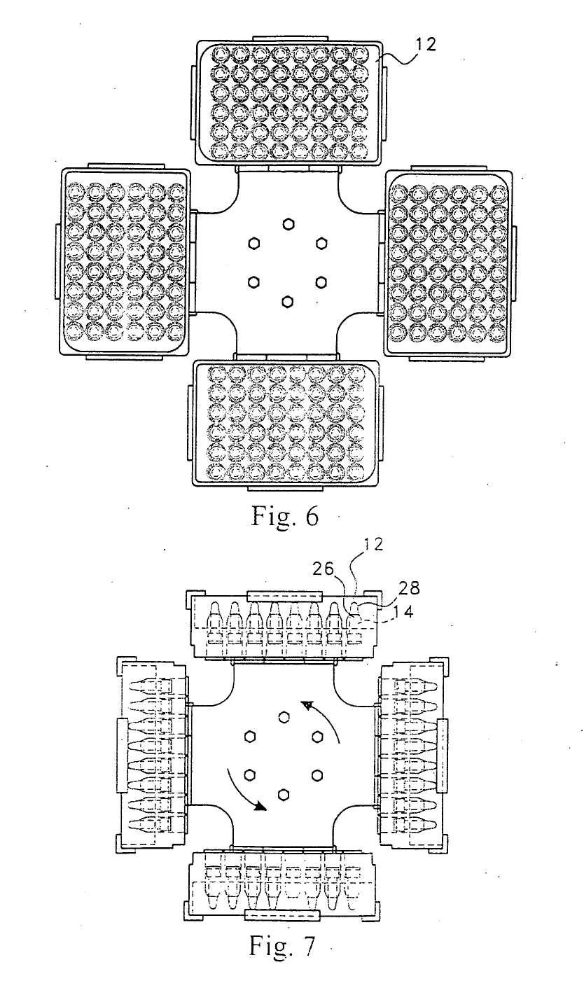

Another part of the method of using the new apparatus is illustrated in FIG. 6 and FIG. 7. The new apparatus is mounted in a centrifuge as depicted in FIG. 6 after a cleaving reaction has been carried out to cleave a product from a reactor. The apparatus is subjected to centrifugal force for moving the cleaved product from the reactor 26 to the cavity 28. Evaporation of any solvent present in the receiving container will leave the cleaved product in the cavity 28. Preferably the evaporation is by use of a partial vacuum. This may be done either during centrifugation, or after centrifugation, but is preferably simultaneously with the centrifugation. The reactor 26 may be removed by the operation described in FIG. 5 above. The cleaved product is then available for further use in cavity 28 of the receiving container 14. The receiving container 14 may be removed from the receiving container holder 12 as described above by application of mechanical force to the second bore end of the receiving container. The amount of mechanical force necessary for this removal is an amount sufficient to overcome the removable engagement used.

Preferably, the array of receiving position bores has a number of such bores selected from: 48 bores, 96 bores and 384 bores. More preferably, the array has 48 bores. The 48 bore preferred embodiment array has the same footprint as a 96 well microtiter plate, and is particularly well suited for use in automated chemical synthesis procedures due to the wide availability of robotic equipment for use with the 96 well microtiter plate format. The use of this format reduces the need for specially modified equipment or customized software for using the array. This plate format has a characteristic footprint size of about 85 mm by about 130 mm. Other sizes of arrays, using a number of bores different from those indicated as preferred here are still to be contemplated as within the spirit and scope of the present invention. The use of these different sized arrays might simply require the use of accessory processing equipment that would be different from that used for the microtiter plate format. It is to be understood that other numbers of receiving position bores can be present in the inventive receiving container holder, without departing from the spirit and teaching of the invention.

By vacuum here is meant reduced pressure over the receiving container. This vacuum may be a reduced pressure that is referred to in the art as a “partial vacuum.”

The present invention is not to be limited in scope by the specific embodiments described herein, which are intended as illustrative examples of the invention. Indeed, various modifications of the invention, in addition to those described herein will become apparent to those skilled in the art from the foregoing description and accompanying figures. Such modifications are intended to fall within the scope of the appended claims.

What is claimed is:

1. An apparatus for use in chemical synthesis, comprising:
at least one reactor, the at least one reactor comprising an active solid surface for solid-phase synthesis of a product;
at least one receiving container, the at least one receiving container having a bore dimensioned to receive the at least one reactor at a first bore end, and having a cavity for receiving a reaction product, the cavity disposed at a second bore end and depending from the is receiving container bore, the cavity having a diameter less than a diameter of the bore; and
a receiving container holder, the receiving container holder having a plurality of holding position bores disposed in a horizontal array, each of the plurality of holding position bores extending vertically through the receiving container holder;
wherein the at least one receiving container is removably engageable to at least one of the plurality of holding position bores, for retaining the at least one receiving container to the receiving container holder when the receiving container holder is inverted.

2. The apparatus according to claim 1, wherein the cavity is tapered.

3. The apparatus according to claim 1, wherein the array is rectangular.

4. The apparatus according to claim 1, wherein the removable engagement is by a friction fit.

5. The apparatus according to claim 1, wherein the removable engagement is by elastic deformation of both the receiving container and the receiving container holder.

6. The apparatus according to claim 1, wherein the removable engagement is by elastic deformation of either the receiving container or the receiving container holder.

7. The apparatus according to claim 6, wherein the removable engagement is by elastic deformation of the receiving container.

8. The apparatus according to claim 6, wherein the removable engagement is by elastic deformation of the receiving container holder.

9. The apparatus according to claim 1, further comprising at least one indexing element, for sensing the orientation of the apparatus in a horizontal plane.

10. The apparatus according to claim 9, wherein the apparatus has four spaced apart corners in a horizontal plane, each of the four spaced apart corners having a shape; and wherein the shape of at least one of the four spaced apart corners is shaped differently from the shape of the other of the four spaced apart corners.

11. The apparatus according to claim 9, wherein the at least one indexing element is a rounded portion of the periphery of the receiving container holder.

12. The apparatus according to claim 9, wherein the at least one indexing element is a protruding portion depending from the periphery of the receiving container holder.

11. The apparatus according to claim 1, wherein the receiving container holder has 48 holding position bores.

12. The apparatus according to claim 1, wherein the receiving container holder has 96 holding position bores.

13. A method for separating a substance from an active solid surface, comprising:
a) providing an apparatus according to claim 1;
b) cleaving the product from the active solid surface of the at least one reactor, while the at least one reactor is received within the at least one receiving container;
c) collecting the cleaved product in the cavity of the at least one receiving container by application of centrifugal force;
d) evaporating any solvent present in the at least one receiving container; and
e) removing the at least one reactor from the at least one receiving container by inversion of the at least one receiving container from a first, reactor retaining position to a second, reactor releasing position.

14. The method according to claim 13, further comprising:
f) removing the at least one receiving container from the apparatus by application of a mechanical force to the second bore end of the at least one receiving container.

15. The method according to claim 13, wherein steps c) and d) are performed simultaneously.
